(19) United States
(12) Patent Application Publication
(10) Pub. No.: US 2013/0192562 A1
(43) Pub. Date: Aug. 1, 2013

(54) FUEL INJECTION CONTROL DEVICE AND FUEL INJECTION METHOD FOR INTERNAL COMBUSTION ENGINE

(71) Applicant: Eriko MATSUMURA, Susono-shi (JP)

(72) Inventor: Eriko MATSUMURA, Susono-shi (JP)

(21) Appl. No.: 13/741,608

(22) Filed: Jan. 15, 2013

(30) Foreign Application Priority Data
Feb. 1, 2012 (JP) 2012-019864

(51) Int. Cl. F02M 69/04

(52) U.S. Cl. CPC F02M 69/04
USPC 123/445

(57) ABSTRACT

A fuel injection control device is provided for an internal combustion engine which includes a fuel injection valve including: a housing which includes a fuel passage, a sac portion, an injection hole, and a valve seat portion; a needle valve which reciprocates in the housing and comes into contact with the valve seat portion; and a drive unit which opens and closes the needle valve. The fuel injection control device includes an injection control portion that performs control for the drive unit to perform a plurality of injections including at least a first injection and a second injection, the first injection being performed by opening the needle valve to an intermediate lift, and the second injection being started when the needle valve is closing after the first injection and being performed by opening the needle valve to a full lift.

The disclosure of Japanese Patent Application No. 2012-019864 filed on Feb. 1, 2012 including the specification, drawings and abstract is incorporated herein by reference in its entirety.

### BACKGROUND OF THE INVENTION

1. Field of the Invention

The present invention relates to a fuel injection control device and a fuel injection method for an internal combustion engine, and more particularly, to a fuel injection control device and a fuel injection method for an internal combustion engine which includes an in-cylinder fuel injection valve that injects fuel directly into a cylinder.

2. Description of Related Art

In internal combustion engines for automobiles, a direct-injection internal combustion engine, in which fuel is injected directly into the combustion chamber, instead of injecting into the intake port, to generate a mixed gas of air and fuel in the combustion chamber, is conventionally known. In a direct-injection internal combustion engine, air is drawn from the intake port into the combustion chamber when the intake valve is opened and then compressed by the piston, and fuel is injected directly into the high-pressure air from the fuel injection valve. Then, the high-pressure air and atomized fuel are mixed in the combustion chamber and the resulting air-fuel mixture is ignited by a spark plug and combusted. Then, when the exhaust valve is opened, exhaust gas is discharged through the exhaust port.

In such a direct-injection internal combustion engine, a fuel injection device includes a housing in which a sac portion and an injection hole are provided at an end of the housing; and a needle valve which is movable in the housing and comes into contact with a valve seat portion located at the base of the sac portion and which is pressed and supported to close the fuel passage. The fuel in the fuel passage is injected from the injection hole through the sac portion into the combustion chamber by moving the needle valve to open the fuel passage at predetermined timings.

In the fuel injection device that is applied to the direct-injection internal combustion engine, because the sac portion is filled with a predetermined amount of fuel and then fuel is injected through the injection hole, not all the fuel is injected into the combustion chamber but some remains in the sac portion when the fuel passage is closed by the needle valve as the fuel injection duration has been completed. In this case, the outside air which contains combustion gas is sucked into the sac portion through the injection hole when the fuel injection is completed (when the needle valve is closed) (this phenomenon is called “air suction during valve closure”). In this case, the fuel which has adhered to and remained on and around the sac portion is steamed by the combustion gas and is accumulated as deposit on the inner surface of the sac portion, the end face of the needle valve or the valve seat portion.

The deposit is preferably removed because accumulation of a large amount of deposit adversely affects the fuel injection amount characteristics. Thus, a technique for determining when to remove deposit and removing the deposit by increasing the fuel injection pressure to blow it away has been conventionally proposed (Japanese Patent Application Publication No. 2002-13436 (JP 2002-13436 A). It is also proposed to supply fuel at a higher pressure than that during normal operation for a predetermined period of time when the engine is started so that fuel can be injected at a high pressure from the fuel injection valve (Japanese Patent Application Publication No. 2005-90231 (JP 2005-90231 A)).

In both the fuel injection devices that are disclosed in JP 2002-13436 A and JP 2005-90231 A, the deposit is removed by increasing the fuel injection pressure. However, with the technique for removing deposit by increasing the fuel injection pressure, the deposit cannot be removed sufficiently because the fuel injection pressure cannot be increased over the entire operating range of the internal combustion engine because of the limitation of the dynamic range of the fuel injection valve. In particular, no effect can be expected on the deposit that has accumulated on the valve seat.

Specifically, it has been found that in a fuel injection device in which deposit is accumulated on the valve seat portion as described above as a background art, if air is present (in other words, no fuel is present) in the sac portion when the needle valve is opened, the flow speed of fuel downstream of the valve seat portion decreases because a rapidly expanding flow is generated along the portion of the housing from the valve seat portion to the sac portion when the valve is opened. As a result, because the generation of cavitation in the fuel flow is unstable, the peel force is too weak to remove the deposit sufficiently.

### SUMMARY OF THE INVENTION

The present invention provides a fuel injection control device and a fuel injection method for an internal combustion engine, which can stably generate cavitation for, for example, removal of deposit without increasing the fuel injection pressure.

A first aspect of the present invention relates to a fuel injection control device for an internal combustion engine which includes a fuel injection valve including: a housing which includes a fuel passage, a sac portion, an injection hole, and a valve seat portion located at a base of the sac portion, the sac portion and the injection hole being provided at an end portion of the housing, and communicating with the fuel passage; a needle valve which reciprocates in the housing and comes into contact with the valve seat portion; and a drive unit which opens and closes the needle valve. The fuel injection control device includes an injection control portion that performs control for the drive unit so that a plurality of injections including at least a first injection and a second injection are performed, the first injection being performed by opening the needle valve to an intermediate lift, and the second injection being started when the needle valve is closing after the first injection and being performed by opening the needle valve to a full lift.

While the term “injection” generally refers to the “injection” of fuel to the outside through an injection hole of the fuel injection valve, the term “injection” is herein also used to mean that fuel flows from the fuel passage into the sac portion through the valve seat portion.

According to the fuel injection control device of the above aspect, the drive unit is controlled by the injection control portion so as to perform a plurality of injections including at least the first injection and the second injection. The first injection is performed by opening the needle valve to an intermediate lift. The second injection is started when the needle valve is closing after the first injection and is performed by opening the needle valve to a full lift. Thus, when the first injection is performed by opening the needle valve to an intermediate lift, the sac portion is filled with fuel. Then, when the second injection, which is started when the needle valve is closing after the first injection, is performed by opening the needle valve to a full lift, fuel is supplied into the sac portion, which has been filled with fuel, from the fuel passage through the valve seat portion, and then fuel is injected to the outside through the injection hole. Because the second injection is started when the needle valve is closing after the first injection, air suction into the sac portion does not occur during valve closure and the sac portion has been filled with fuel. This ensures the generation of cavitation in the small gap between the needle valve and the portion of the housing from the valve seat portion to the sac portion, and when deposit is present, for example, it is peeled and removed. When the sac portion is not filled with fuel (when air is present in the sac portion), the generation, growth and collapse of cavitation are hindered. This is because when air is present, the air functions as a damper and hinders the growth of cavitations (a gas phase that is formed by depressurization boiling of fuel).

In the fuel injection control device according to the above-described aspect of the present invention, a valve opening speed of the needle valve for the second injection may be higher than the valve opening speed of the needle valve for the first injection. In this case, because the small gap between the needle valve and the portion of the housing from the valve seat portion to the sac portion, which serves as the flow path for the second injection, is formed quickly, the flow path resistance decreases, leading to a decrease in pressure loss.

In the fuel injection control device according to the above-described aspect of the present invention, the injection control portion may perform the control when the internal combustion engine is in a predetermined operating condition. The injection control portion may perform the control when the internal combustion engine is in the predetermined operating condition in which an expansion stroke is performed while catalyst warm-up control is performed. According to this aspect, because a predetermined small amount of fuel is injected during expansion stroke in addition to the normal fuel injection amount, the catalyst warm-up function is enhanced and deterioration of emissions is prevented.

The fuel injection control device according to the above-described aspect may further include a defect estimation portion for the valve seat portion. The configuration may be such that the injection control portion does not perform the control when the defect estimation portion estimates that the valve seat portion has a defect. According to this aspect, because the injection control portion does not perform the control when the valve seat portion is estimated to have a defect that is caused by erosion thereof which results from excessive generation of cavitation, the defect of the valve seat is prevented from progressing. Thus, a decrease in oil-tightness of the fuel injection valve due to a defect of the valve seat is prevented and deterioration of emissions is prevented.

The fuel injection control device according to the above-described aspect may further include a mixing proportion determination portion which determines a proportion of ethanol; and a valve opening speed change portion which changes the valve opening speed for the second injection based on the proportion of ethanol that is determined by the mixing proportion determination portion. According to this aspect, the valve opening speed for the second injection is changed based on the proportion of ethanol by the valve opening speed change portion. Thus, because the valve opening speed for the second injection is changed according to the saturated vapor pressure, which depends on the proportion of ethanol, the pressure during valve opening becomes closer to the saturated vapor pressure and the generation of cavitation is stabilized.

The fuel injection control device according to the above-described aspect may further include a valve opening speed limit portion which limits the valve opening speed for the second injection so that the valve opening speed for the second injection does not exceed a predetermined value. According to this aspect, the valve opening speed limit portion limits the valve opening speed for the second injection so that the valve opening speed for the second injection does not exceed a predetermined value, for example, a value at which the pressure drops to a pressure on the saturated vapor line for ethanol. Thus, because the valve opening speed is prevented from increasing to a value at which the pressure drops to or below a pressure on the saturated vapor line for ethanol, the fuel is prevented from changing completely to gas and the injection amount is prevented from becoming uncontrollable. This ensures the accuracy of the injection amount control.

A second aspect of the present invention relates to a fuel injection method for an internal combustion engine which includes a fuel injection valve including: a housing which includes a fuel passage, a sac portion, an injection hole, and a valve seat portion located at a base of the sac portion, the sac portion and the injection hole being provided at an end portion of the housing, and communicating with the fuel passage; a needle valve which reciprocates in the housing and comes into contact with the valve seat portion; and a drive unit which opens and closes the needle valve. The fuel injection method includes performing a plurality of injections including at least a first injection and a second injection, the first injection being performed by opening the needle valve to an intermediate lift so that the sac portion is filled with fuel, and the second injection being started when the needle valve is closing after the first injection and being performed by opening the needle valve to a full lift so that the fuel is injected through the injection hole.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view which illustrates a fuel injection control device for an internal combustion engine according to an embodiment of the present invention;

FIG. 2 is a cross-sectional view which illustrates a fuel injection valve that is used in an embodiment of the present invention;

FIG. 3 is an enlarged view that illustrates a part of the fuel injection valve of the embodiment that is shown in FIG. 2;

FIG. 4 is a time chart with time on the horizontal axis which is shown to explain a plurality of injections including first and second injections in a first example embodiment of the present invention, wherein the vertical axis (A) represents the drive voltage and the vertical axis (B) represents the valve element lift;

FIG. 5 is a time chart, similar to FIG. 4, which is shown to explain a plurality of injections including first and second injections in a second example embodiment of the present invention;

FIG. 6 is a flowchart that shows the procedure of controlling the fuel injection control device for an internal combustion engine according to the embodiment of the present invention;

FIGS. 7A and 7B are graphs that show the relationship between the valve opening speed and the drive voltage and the relationship between the valve opening speed and the proportion of ethanol, respectively, in a fuel injection valve according to an embodiment of the present invention;

FIG. 8 is a graph that shows the relationship between the pressure during valve opening and the valve opening speed in a fuel injection valve according to an embodiment of the present invention; and

FIG. 9 shows pressure-temperature curves for fuels with different boiling points.

### DETAILED DESCRIPTION OF EMBODIMENTS

Description is hereinafter made of embodiments of the present invention with reference to the accompanying drawings.

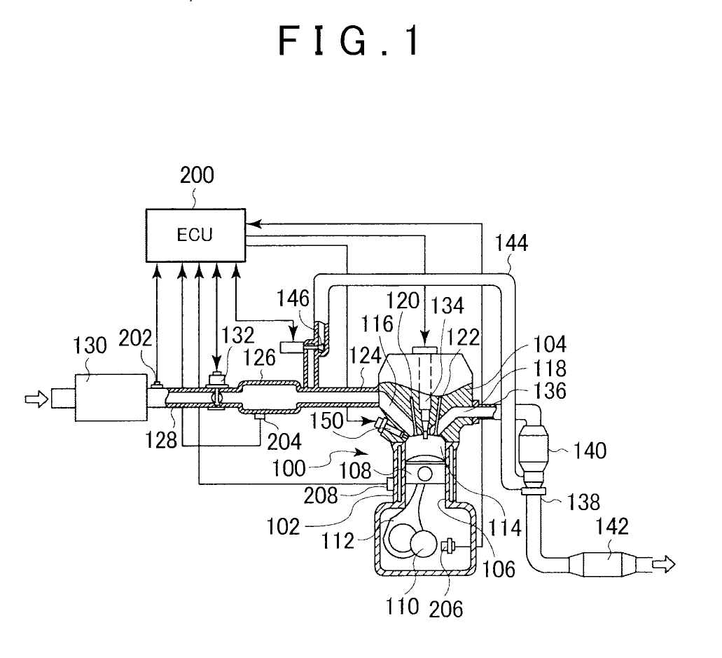

An engine 100 to which a fuel injection device according to the embodiment is applied is a direct-injection spark-ignition engine as shown in FIG. 1. In the engine 100, a cylinder head 104 is fixedly mounted on a cylinder block 102, and a piston 108 is fitted to be movable upward and downward in each of a plurality of cylinder bores 106 that is formed in the cylinder block 102. A crankshaft 110 is rotatably supported in a lower portion of the cylinder block 102, and each piston 108 is coupled to the crankshaft 110 via a connecting rod 112.

Combustion chambers 114 are defined by the cylinder block 102, the cylinder head 104 and the pistons 108, and each of the combustion chambers 114 has the shape of a pent roof, which slopes on two sides from a center peak, for example. An intake port 116 and an exhaust port 118 are formed above each combustion chamber 114, in other words, in the lower surface of the cylinder head 104 in a manner such that the intake port 116 and the exhaust port 118 are opposed to each other, and lower ends of an intake valve 120 and an exhaust valve 122 are located in the intake port 116 and the exhaust port 118, respectively. When the intake valve 120 and the exhaust valve 122 are moved upward and downward at predetermined timings, the intake port 116 and the exhaust port 118 are opened and closed, and thus, the intake port 116 and the combustion chamber 114 communicate with each other, and the combustion chamber 114 and the exhaust port 118 communicate with each other.

A surge tank 126 is coupled to the intake port 116 via an intake manifold 124, and an intake pipe 128 is coupled to the surge tank 126. In addition, the intake pipe 128 has an air inlet to which an air cleaner 130 is attached. An electronic throttle device 132 including a throttle valve is provided downstream of the air cleaner 130. Spark plugs 134, which are located above the combustion chambers 114 and used to ignite air-fuel mixture, are attached to the cylinder head 104.

On the other hand, an exhaust pipe 138 is coupled to the exhaust port 118 via an exhaust manifold 136, and catalyst devices 140 and 142 which purify (convert) pollutants, such as HC, CO and NOx, in exhaust gas are attached to the exhaust pipe 138. An exhaust gas recirculation passage (EGR passage) 144 is provided between a portion of the intake pipe 128 downstream of the surge tank 126 and a portion of the exhaust pipe 138 between the catalyst devices 140 and 142, and an EGR valve 146 is provided in the EGR passage 144.

In addition, injectors (fuel injection devices) 150 that inject fuel directly into the combustion chambers 114 as described later are provided in the cylinder head 104. In this embodiment, each injector 150 is located on the side of the intake port 116 with its distal end inclined downward at a predetermined angle and can inject fuel toward the exhaust port 118.

The vehicle includes an electronic control unit (ECU) 200, and the ECU 200 can control the injectors 150, the spark plugs 134, the EGR valve 146 and so on. An air flow meter 202 is attached upstream of the intake pipe 128 and an intake negative pressure sensor 204 is attached to the surge tank 126, and signals which indicate the measured intake air amount and intake negative pressure are output to the ECU 200. The electronic throttle device 132 outputs a signal which indicates the current throttle opening to the ECU 200, and a crank position sensor 206 outputs a signal which indicates the detected engine rotational speed to the ECU 200. In addition, a signal which indicates the coolant temperature is output to the ECU 200 from a temperature sensor 208 on the cylinder block 102. Thus, the ECU 200 determines the fuel injection amount, injection timing, ignition timing, EGR valve opening and so on based on engine operating condition parameters, such as detected intake air amount, intake negative pressure, throttle opening (or accelerator operation amount), engine rotational speed and coolant temperature.

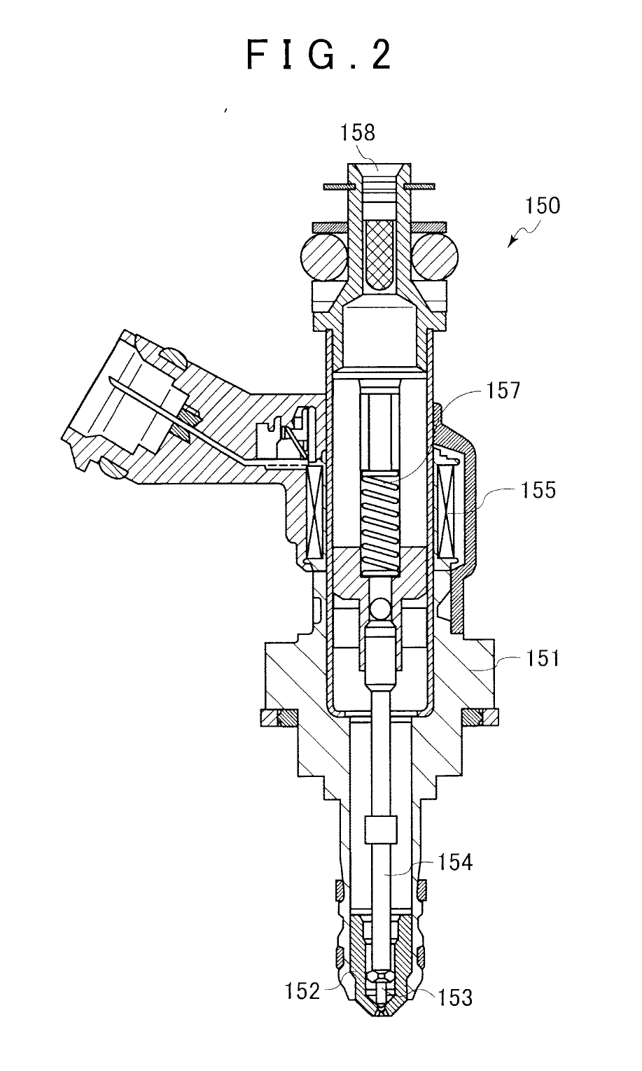

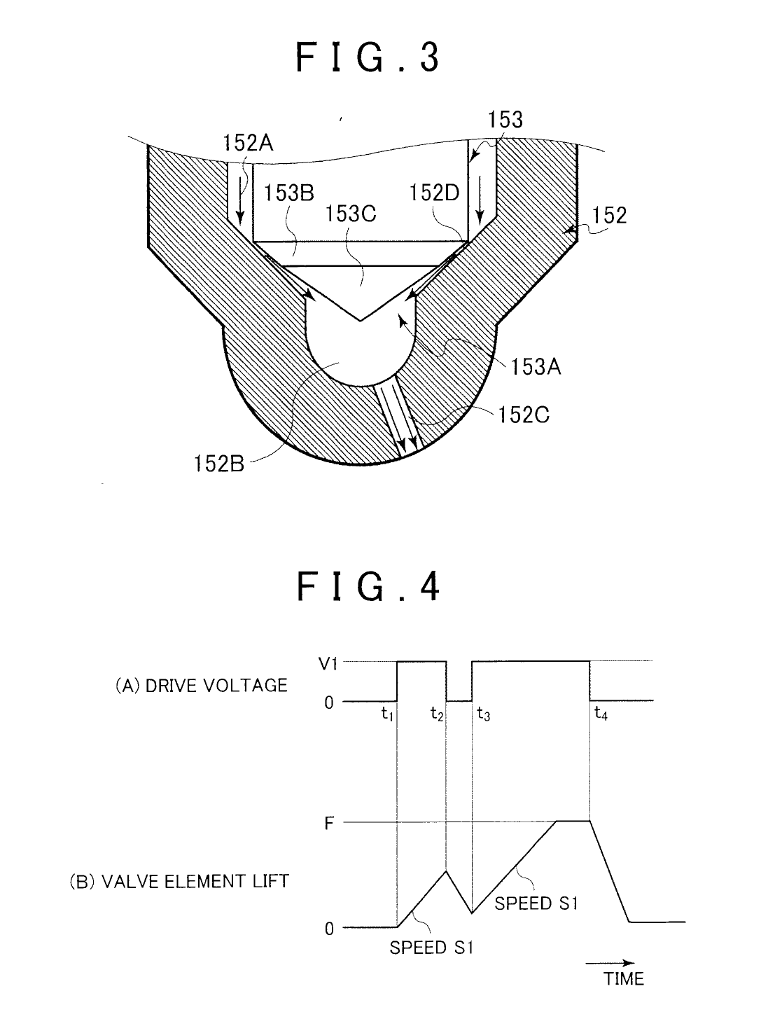

As shown in FIG. 2 and FIG. 3, the injector 150 according to this embodiment includes a housing including a housing body 151 and a spray forming member 152, a needle valve 153 which reciprocates in the housing, and a solenoid 155 which opens and closes the needle valve 153 (i.e., drives the needle valve 153 to open and closed positions). In this embodiment, a fuel passage is formed in a center portion of the housing body 151, and the spray forming member 152 is located at an end portion of the fuel passage. The spray forming member 152 includes a fuel passage 152A that communicates with the fuel passage of the housing body 151. The spray forming member 152 further includes a sac portion 152B and an injection hole 152C which are provided at an end portion of the spray forming member 152 and communicate with the fuel passage, and a valve seat portion 152D located at the base of the sac portion 152B. More specifically, as shown in FIG. 3, the spray forming member 152 with the shape of a hollow cylinder includes the hemispherical sac portion 152B provided at the small-diameter end portion of the spray forming member 152, and a slit-like injection hole 152C (or a plurality of injection holes 152C) which opens to the outside. The valve seat portion 152D, which has a concave cone shape, is located at the base of the sac portion 152B. The spray forming member 152 may be formed integrally with the housing body 151.

The needle valve 153 is formed integrally with an end portion of a columnar plunger 154 which reciprocates in the housing body 151. The needle valve 153 includes a valve element 153A with a double-conical shape provided at an end portion of the needle valve 153. In other words, in the needle valve 153, the outer peripheral surface of the valve element 153A with a double-conical shape includes a needle seat portion 153B parallel to the valve seat portion 152D located at the base of the sac portion 152B, and a needle conical surface 153C on the distal side of the needle seat portion 153B.

The fuel passage 152A between the spray forming member 152 and the needle valve 153 has a lower end which is communicable with the injection hole 152C via the sac portion 152B. The fuel passage 152A is closed when the needle seat portion 153B of the needle valve 153 is in contact with the valve seat portion 152D of the spray forming member 152, whereas the fuel passage 152A is opened and the fuel at a predetermined pressure in the fuel passage 152A is injected to the outside (into the combustion chamber 114) from the injection hole 152C through the fuel passage between the valve seat portion 152D and the needle conical surface 153C and the sac portion 152B when the needle seat portion 153B is separated (lifted) from the valve seat portion 152D.

A coil spring 157 is held in a compressed state in the housing body 151, and the needle valve 153 is pressed by the pressing force of the coil spring 157 via the plunger 154 so that the needle seat portion 153B is held in close contact with the valve seat portion 152D of the spray forming member 152 to close the fuel passage 152A. The solenoid 155 as a drive unit is provided in the wall of the housing body 151 so as to face the plunger 154 of the needle valve 153. Thus, when the solenoid 155 is energized, a suction force is produced and the needle valve 153 is moved (lifted) upward against the pressing force of the coil spring 157 to open the fuel passage 152A.

A fuel pump, a fuel tank and so on are coupled to an inlet 158 at the base end of the injector 150 via a delivery pipe (not shown), and fuel at a predetermined pressure P1 is supplied to the upstream side of the fuel passage 152A of the spray forming member 152 through the fuel passage in the housing body 151.

The function of an injection control portion in the fuel injection control device for an internal combustion engine that has been described above is described below. In the fuel injection valve (injector) 150 of this embodiment, when the solenoid 155 is supplied with a predetermined drive signal and excited, the needle valve 153 is moved (lifted) against the coil spring 157 and the needle seat portion 153B of the needle valve 153 is moved away from the valve seat portion 152D at the base of the sac portion 152B. In this case, the needle valve 153 operates with some delay because of the response lag in electric circuits or the influence of the properties, such as pressure and temperature, of the fuel in the fuel injection valve 150. Thus, the fuel injection valve 150 is fully opened when the needle valve 153 is completely lifted in spite of the delay in operation. In this full open state, the fuel is fed under pressure through the fuel passage 152A of the spray forming member 152, the gap between the needle seat portion 153B of the needle valve 153 and the valve seat portion 152D, and the fuel passage between the valve seat portion 152D and the needle conical surface 153C, and injected from the injection hole 152C.

Therefore, in this embodiment, the injection control portion controls the solenoid 155 so that a plurality of injections including a first injection and a second injection are performed. The first injection is performed by opening the needle valve 153 to an intermediate lift. The second injection is started when the needle valve 153 is closing after the first injection, and is performed by opening the needle valve 153 to a full lift. Specifically, in a first example embodiment, a drive signal with a voltage V1 is applied to the solenoid 155 at time t₁ as shown in FIG. 4. Then, the needle valve 153 starts to be lifted at a speed S1 corresponding to the drive voltage V1. Then, the drive signal is temporarily stopped at time t₂ when the needle valve 153 is still being lifted. Then, the needle valve 153, which is pressed by the coil spring 157, starts closing. Then, a drive signal with a voltage V1 starts to be applied again at t₃ when the needle valve 153 is still closing. Then, the needle valve 153 starts to be lifted again at a speed S1. Then, the drive signal is stopped at t₄ after the needle valve 153 is opened to a full lift F.

Thus, when the first injection is performed by opening the needle valve 153 to an intermediate lift, atomized fuel is fed under pressure from the fuel passage 152A of the spray forming member 152 through the gap between the needle seat portion 153B of the needle valve 153 and the valve seat portion 152D, and the sac portion 152B is filled with the fuel. Then, when the second injection, which is started when the needle valve 153 is closing after the first injection, is performed by opening the needle valve 153 to a full lift, fuel is supplied to the sac portion 152B, which has been filled with fuel, from the fuel passage 152A through the gap between the needle seat portion 153B of the needle valve 153 and the valve seat portion 152D and the fuel passage between the valve seat portion 152D and the needle conical surface 153C, and thus, fuel is injected to the outside through the injection hole 152C. Because the second injection is started when the needle valve 153 is closing after the first injection, air suction into the sac portion 152B does not occur and the sac portion 152B has been filled with fuel. This ensures the generation of cavitation in the small gap between the needle valve 153 and the portion of the spray forming member 152, which extends from the valve seat portion 152D to the sac portion 152B, and the fuel passage between the valve seat portion 152D and the needle conical surface 153C. Thus, when deposit has accumulated on the valve seat portion 152D, the deposit is reliably peeled and removed by the cavitation.

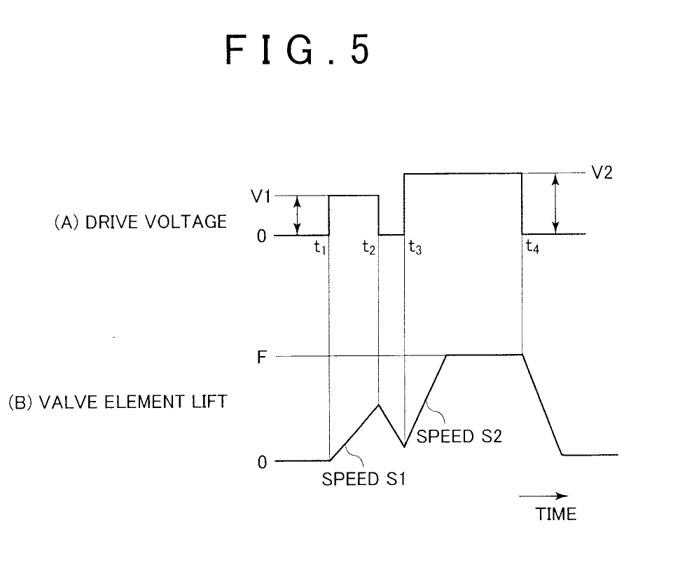

The valve opening speeds of the needle valve 153 for the first and second injections are equal to each other in the above embodiment. However, as shown in FIG. 5, the valve opening speed S2 of the needle valve 153 for the second injection is preferably higher than the valve opening speed S1 of the needle valve 153 for the first injection. For this reason, in a second example embodiment that is shown in FIG. 5, the voltage of the drive signal that is applied at t₃ at which the needle valve 153 is closing is increased to V2 (V2>V1). In this case, because the small gap between the needle valve 153 and the portion of the spray forming member 152 from the valve seat portion 152D to the sac portion 152B, which serves as the flow path for the second injection, is formed quickly, the flow path resistance decreases, leading to a decrease in pressure loss.

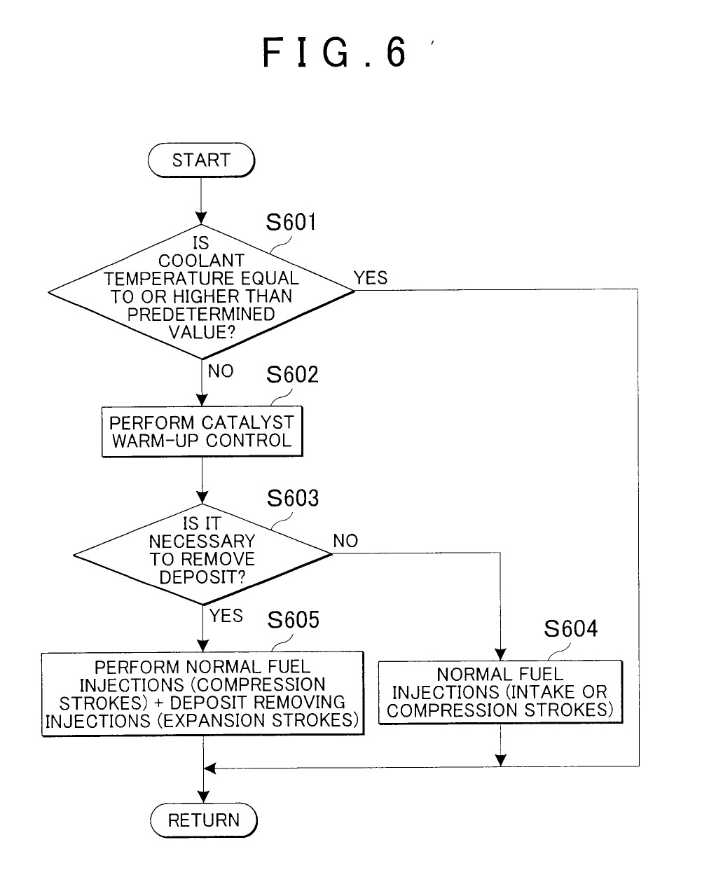

An example of the control procedure, which includes the injection control described above, and in which the fuel injection control device for an internal combustion engine according to the embodiment of the present invention is used to remove deposit, is next described with reference to the flowchart of FIG. 6. This control is performed at predetermined intervals after the start of the engine 100. First, when the control is started, the ECU 200 determines in step S601 whether the coolant temperature is equal to or higher than a predetermined value based on a detection signal from the temperature sensor 208. When the coolant temperature is lower than the predetermined value, the ECU 200 assumes that the temperatures of the catalysts 140 and 142 have not reached their activation temperatures and proceeds to step S602 to perform catalyst warm-up control. When the coolant temperature is determined to be equal to or higher than the predetermined value in step S601, the current control routine ends.

Then, it is determined in step S603 whether removal of deposit from the fuel injection valve 150 is necessary. The determination as to whether removal of deposit is necessary can be made by various known methods. For example, the determination may be made by measuring the change in air-fuel ratio after a predetermined amount of fuel is injected a predetermined number of times. When removal of deposit is not necessary, the process proceeds to step S604 and normal fuel injections are performed. In other words, a fuel injection amount based on the engine operating condition parameters of the engine 100 is injected from the fuel injection valve 150 during each compression (or intake) stroke of the engine 100. In contrast, when removal of deposit is necessary, the process proceeds to step S605 and the deposit removing injections are performed in addition to the normal fuel injections. Specifically, a small amount of fuel is injected from the fuel injection valve 150 during each expansion stroke in addition to the fuel injection amount that is injected from the fuel injection valve 150 during each compression (or intake) stroke of the engine 100 based on the engine operating condition parameters of the engine 100.

While it is determined whether removal of deposit from the fuel injection valve 150 is necessary in step S603 in the control procedure that is described above, the process may proceed to step S605 without making the determination so that the deposit removing injections are performed in addition to the normal fuel injections whenever the catalyst warm-up control in step S602 is performed.

According to these control procedures, because a predetermined small amount of fuel is injected during each expansion stroke in addition to the normal fuel injection amount, the catalyst warm-up function is enhanced and deterioration of emissions can be prevented.

In the embodiment of the present invention that is described above, a plurality of injections including the first injection and the second injection are performed to stably generate cavitation. The first injection is performed by opening the needle valve 153 to an intermediate lift. The second injection is started when the needle valve 153 is closing after the first injection and is performed by opening the needle valve 153 to a full lift. However, excessive generation of cavitation may cause erosion of the valve seat portion, which may lead to a defect of the valve seat portion and a decrease in oil-tightness between the valve seat portion and the needle valve 153. Thus, in a different embodiment of the present invention, a defect estimation portion for the valve seat is provided, and when the defect estimation portion estimates that the valve seat portion has a defect, a deposit removing injection control portion does not perform the control.

For example, the defect estimation portion for the valve seat portion may detect whether there is rotational fluctuation which exceeds a predetermined threshold value during cranking when the engine 100 is restarted at a high temperature, and may determine that the valve seat portion has a defect when there is the rotational fluctuation. This is because when there is a defect of the valve seat portion (decrease in oil-tightness), a phenomenon occurs in which the fuel that has leaked into the combustion chamber 114 undergoes self-ignition (pre-ignition) before the initial injection from the fuel injection valve 150 is performed. According to this embodiment, because the deposit removing injection control portion does not perform the control when the valve seat portion is estimated to have a defect that is caused by erosion thereof which results from excessive generation of cavitation, the defect of the valve seat is prevented from progressing. Thus, a decrease in oil-tightness of the fuel injection valve due to a defect of the valve seat is prevented and deterioration of emissions is prevented.

In addition, the fuel injection control device of the present invention is applicable to an internal combustion engine which uses an ethanol mixed fuel, i.e., gasoline mixed with a predetermined proportion of alcohol (ethanol), as the fuel instead of gasoline. A fuel injection control device according to an embodiment of the present invention is applied to an internal combustion engine that uses an ethanol mixed fuel. The fuel injection control device may include a mixing proportion determination portion which determines the proportion of ethanol, and a valve opening speed change portion which changes the valve opening speed for the second injection, based on the proportion of ethanol that is determined by the mixing proportion determination portion. The second injection is started when the needle valve is closing after the first injection, and is performed by opening the needle valve 153 to a full lift. This is because the higher the proportion of ethanol becomes, the higher the boiling point of the fuel becomes and the less stable the generation of cavitation becomes.

The ethanol mixed fuel is described briefly for easy understanding with reference to the pressure-temperature diagram of FIG. 9. In general, gasoline is a multi-component fuel, that is, a mixture of components with low boiling points (components which evaporate quickly) and components with high boiling points (components which evaporate slowly). In the pressure-temperature diagram of FIG. 9, the saturated vapor line for a low-boiling point component (for example, n-pentane (C5), a hydrocarbon component with a carbon number of 5) is denoted by “A,” and the saturated vapor line for a high-boiling point component (for example, n-tridecane (C13), a hydrocarbon component with a carbon number of 13) is denoted by “B.” It is known that in the case of a multi-component fuel, a two-phase region with a certain width which is surrounded by a saturated liquid line on the liquid phase side and a saturated vapor line on the gas phase side is present, and the saturated liquid line and the saturated vapor line meet at a critical point. Thus, in FIG. 9, the two-phase region (hatched with lines sloping up from left to right) in the case of gasoline free of ethanol is denoted by “C,” and the two-phase region (hatched with lines sloping up from right to left) in the case of gasoline mixed with a predetermined proportion of ethanol is denoted by “D.” Their saturated liquid lines E, saturated vapor lines F and critical points CP are distinguished by adding a subscript, as in E_{C} in the case of the saturated liquid lines E, when necessary. In addition, FIG. 9 schematically shows the case where the fuel at a predetermined fuel injection pressure P1 which is supplied to the upstream side of the needle valve 153 is injected at a predetermined fuel temperature T1. In other words, the fuel pressure at the valve seat portion 152 at the time when the needle valve 153 is opened is denoted by P2, and the saturated vapor pressure Pv corresponding to the saturated vapor line F_{C} in the case of gasoline free of ethanol and the saturated vapor pressure Pvα corresponding to the saturated vapor line F_{d} in the case of gasoline mixed with a predetermined proportion α of ethanol.

As the mixing proportion determination portion which determines the proportion of ethanol, a well-known ethanol concentration sensor may be used. The ethanol concentration sensor may be located in the fuel tank (not shown) or a fuel supply passage which connects the fuel tank and the fuel injection valve 150, for example. In order to change the valve opening speed for the second injection based on the proportion of ethanol that is detected by the ethanol concentration sensor, the ECU 200 increases the voltage of the drive signal from the voltage of the drive signal for the first injection, and applies the drive signal with the increased voltage to the solenoid 155 of the fuel injection valve 150.

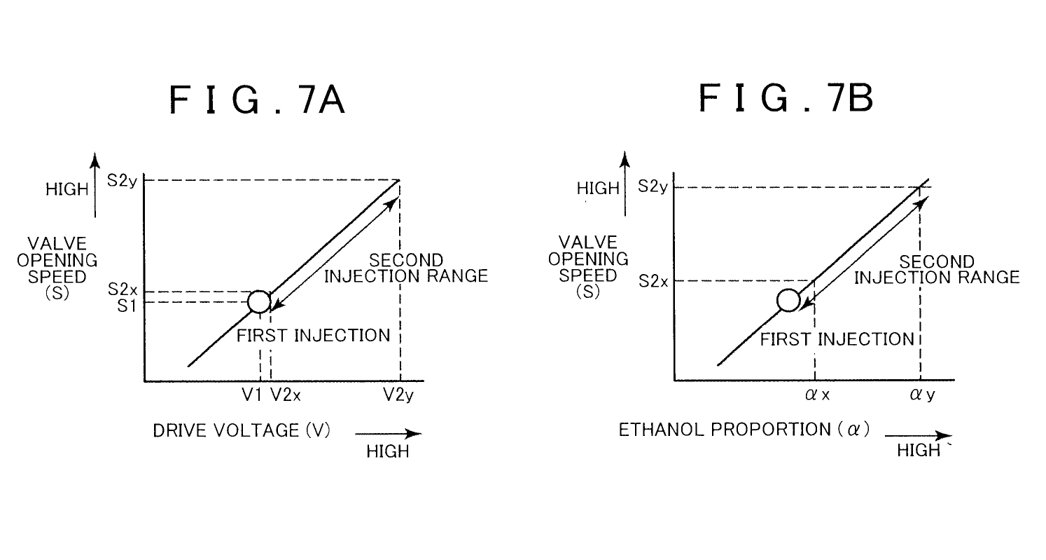

The application of the increased voltage is described in detail with reference to FIG. 7B, which shows the relationship between the ethanol proportion α and the valve opening speed S suitable for each ethanol proportion α, and FIG. 7A, which shows the relationship between the valve opening speed S and the drive voltage V suitable for achieving the valve opening speed S. In FIG. 7B, the valve opening speed for the second injection when the ethanol proportion is ax is defined as “S2x,” and the valve opening speed for the second injection when the ethanol proportion is αy, which is higher than ax, is defined as “S2y.” To obtain the valve opening speed S2x or S2y, the drive voltage V2 for the second injection (refer to FIG. 5) is increased to V2x or V2y compared to the drive voltage V1 for the first injection. According to this configuration, because the valve opening speed S2 for the second injection is changed according to the saturated vapor pressure Pvα, which depends on the ethanol proportion a, the pressure P2 during valve opening becomes closer to the saturated vapor pressure and the generation of cavitation is stabilized.

However, when the valve opening speed S2 for the second injection is unlimitedly increased based on the ethanol proportion α as in the above embodiment, in other words, when the valve opening speed S2 for the second injection is increased until the pressure falls below the pressure Pvα on the saturated vapor line for ethanol, a pressure drop due to sudden opening of the needle valve 153 causes the fuel to boil and causes the fuel to change completely from liquid to gas. Thus, in a further embodiment of the present invention, a valve opening speed limit portion, which limits the valve opening speed S2 for the second injection so that the valve opening speed S2 does not exceed a predetermined value S2z, is provided.

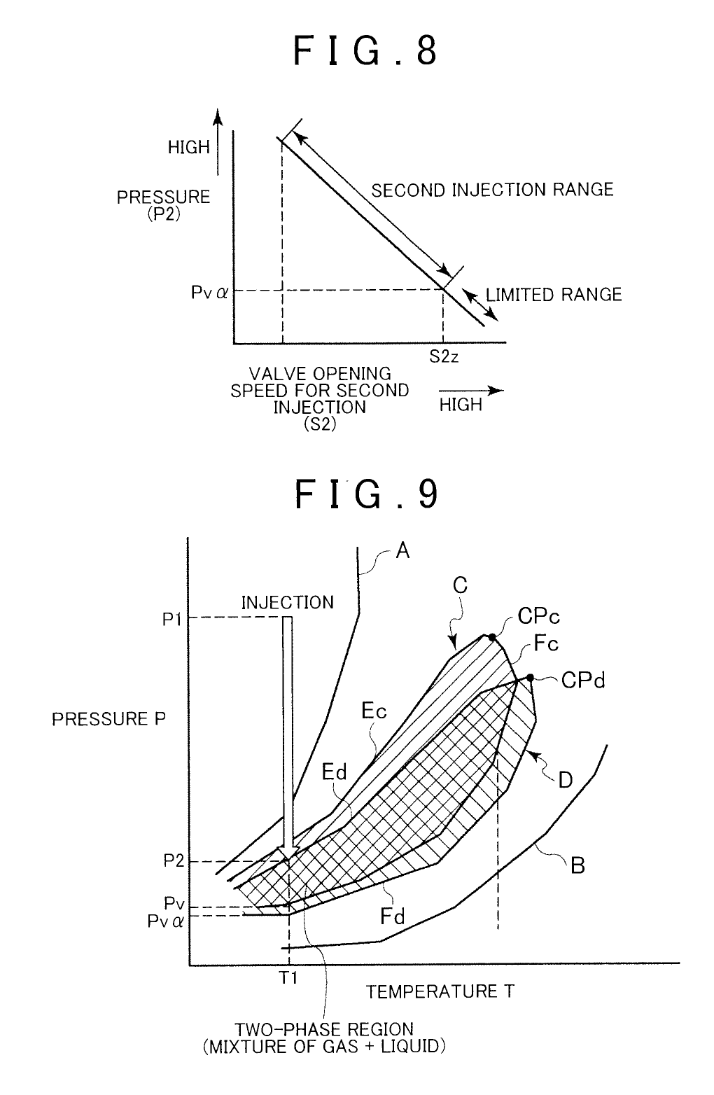

Referring to the graph of FIG. 8, which shows the relationship between the valve opening speed S2 for the second injection and the pressure P2 during valve opening, the valve opening speed S2 for the second injection is limited so that the valve opening speed S2 does not exceed the predetermined value S2z at which the pressure P2 during valve opening drops to the pressure Pvα on the saturated vapor line for ethanol. In other words, the drive voltage V for achieving the valve opening speed is limited. According to this configuration, because the valve opening speed limit portion limits the valve opening speed S2 for the second injection so that the valve opening speed S2 does not exceed the predetermined value S2z, the valve opening speed is prevented from increasing to a value at which the pressure drops to or below the pressure Pvα on the saturated vapor line F_{d} in the case where ethanol is mixed with gasoline. Thus, because the fuel is prevented from changing completely to gas, the injection amount is prevented from becoming uncontrollable. This ensures the accuracy of the injection amount control.

While embodiments of the present invention have been described in the foregoing, it is to be understood that the present invention is not limited to the above embodiments and various changes and modifications can be made within the scope of the present invention.

What is claimed is:

1. A fuel injection control device for an internal combustion engine which includes a fuel injection valve including: a housing which includes a fuel passage, a sac portion, an injection hole, and a valve seat portion located at a base of the sac portion, the sac portion and the injection hole being provided at an end portion of the housing, and communicating with the fuel passage; a needle valve which reciprocates in the housing and comes into contact with the valve seat portion; and a drive unit which opens and closes the needle valve, the fuel injection control device comprising
an injection control portion that performs control for the drive unit so that a plurality of injections including at least a first injection and a second injection are performed, the first injection being performed by opening the needle valve to an intermediate lift, and the second injection being started when the needle valve is closing after the first injection and being performed by opening the needle valve to a full lift.

2. The fuel injection control device according to claim 1, wherein a valve opening speed of the needle valve for the second injection is higher than the valve opening speed of the needle valve for the first injection.

3. The fuel injection control device according to claim 1, wherein the injection control portion performs the control when the internal combustion engine is in a predetermined operating condition.

4. The fuel injection control device according to claim 3, wherein the injection control portion performs the control when the internal combustion engine is in the predetermined operating condition in which an expansion stroke is performed while catalyst warm-up control is performed.

5. The fuel injection control device according to claim 3, further comprising
a defect estimation portion for the valve seat portion, wherein the injection control portion does not perform the control when the defect estimation portion estimates that the valve seat portion has a defect.

6. The fuel injection control device according to claim 2, further comprising:
a mixing proportion determination portion which determines a proportion of ethanol; and
a valve opening speed change portion which changes the valve opening speed for the second injection based on the proportion of ethanol that is determined by the mixing proportion determination portion.

7. The fuel injection control device according to claim 6, further comprising
a valve opening speed limit portion which limits the valve opening speed for the second injection so that the valve opening speed for the second injection does not exceed a predetermined value.

8. A fuel injection method for an internal combustion engine which includes a fuel injection valve including: a housing which includes a fuel passage, a sac portion, an injection hole, and a valve seat portion located at a base of the sac portion, the sack portion and the injection hole being provided at an end portion of the housing, and communicating with the fuel passage; a needle valve which reciprocates in the housing and comes into contact with the valve seat portion; and a drive unit which opens and closes the needle valve, the fuel injection method comprising
performing a plurality of injections including at least a first injection and a second injection, the first injection being performed by opening the needle valve to an intermediate lift so that the sac portion is filled with fuel, and the second injection being started when the needle valve is closing after the first injection and being performed by opening the needle valve to a full lift so that the fuel is injected through the injection hole.

9. The fuel injection method according to claim 8, wherein a valve opening speed of the needle valve for the second injection is higher than the valve opening speed of the needle valve for the first injection.
